(19) United States
(12) Patent Application Publication
(10) Pub. No.: US 2026/0241602 A1
(43) Pub. Date: Aug. 20, 2026

(54) ANTI-SCRATCH PAPER CUTTING AND DISCHARGING MECHANISM AND PAPER DISPENSER

(71) Applicant: FANER AROMA PRODUCT CO., LTD., Baiyun District (CN)

(72) Inventors: Hsu-hui CHANG, Baiyun District (CN); Songwen YE, Baiyun District (CN); Yingyao LIU, Baiyun District (CN); Chia-Yu CHANG, Baiyun District (CN)

(21) Appl. No.: 19/189,138

(22) Filed: Apr. 24, 2025

(30) Foreign Application Priority Data
Feb. 19, 2025 (CN) 202520265491.6

(51) Int. Cl. B26D 7/22; B26D 1/02; B65H 35/00

(52) U.S. Cl. CPC B26D 7/22; B26D 1/025; B65H 35/008

(57) ABSTRACT

An anti-scratch paper cutting and discharging mechanism includes: a paper outlet, a cutter and a baffle. The cutter extends in a transverse direction and is arranged on one inner side of the paper outlet, and a first paper discharge gap is defined between the cutter and the paper outlet. The baffle is rotatably arranged at the paper outlet. The cutter and the baffle are arranged in sequence along a paper discharge direction of the paper outlet. A rotation axis of the baffle extends in the transverse direction and is arranged adjacent to the cutter. One end of the baffle away from the rotation axis of the baffle is a rotating end, a second paper discharge gap is defined between the rotating end and the paper outlet, and a width of the second paper discharge gap is smaller than a width of the first paper discharge gap.

### TECHNICAL FIELD

The present disclosure relates to the technical field of paper dispensers, and in particular, to an anti-scratch paper cutting and discharging mechanism and a paper dispenser.

### BACKGROUND

As a tool for holding paper rolls, the paper distributor is suitable for usage scenarios such as kitchens, or bathrooms. In order to achieve paper breaking, currently, a cutter is provided at a paper outlet, and the paper rolls are cut off through the cutter. In actual use, the paper roll may become lodged inside the paper outlet, requiring the user to reach into the paper outlet with his/her hand, to pull out the paper roll. This action risks accidental contact with the cutter, leading to scratches to the user's hand. Even during normal operation, the user's hand may inadvertently touch the cutter while reaching into the paper outlet.

### SUMMARY

An objective of the present disclosure is to provide an anti-scratch paper cutting and discharging mechanism and a paper dispenser, to address one or more technical problems in the existing technologies, at least providing a beneficial choice or creating conditions.

The technical solutions used to address the above-mentioned technical problems are as follows.

In one aspect, an embodiment of the present disclosure provides an anti-scratch paper cutting and discharging mechanism including:
a paper outlet;
a cutter extending in a transverse direction and arranged on one of inner sides of the paper outlet, where a first paper discharge gap is defined between the cutter and the paper outlet; and
a baffle rotatably arranged at the paper outlet, where the baffle and the cutter are located on a same inner side of the paper outlet, the cutter and the baffle are arranged in sequence along a paper discharge direction of the paper outlet, a rotation axis of the baffle extends in the transverse direction and is arranged adjacent to the cutter, one end of the baffle away from the rotation axis of the baffle is a rotating end, a second paper discharge gap is defined between the rotating end and the paper outlet, and a width of the second paper discharge gap is smaller than a width of the first paper discharge gap, such that the rotating end is capable of covering the cutter by rotating in a direction opposite to the paper discharge direction.

The beneficial effects of the paper cutting and discharging mechanism provided by the present disclosure are as follows.

When in use, the paper is output along the first paper discharge gap and the second paper discharge gap. When the paper needs to be cut off, the paper is pulled such that the paper is in contact with the cutter, and the paper is cut off by the cutter. When a user reaches into the paper outlet with his/her hand, the baffle will swing with the hand to cover the cutter, and prevent the hand from touching the cutter, thereby achieving an anti-scratch effect without affecting normal paper discharge.

As a further improvement of the above-mentioned technical solution, the paper cutting and discharging mechanism further includes a paper guide strip; and the paper guide strip is arranged on one side of the cutter away from the baffle.

As a further improvement of the above-mentioned technical solution, the paper cutting and discharging mechanism further includes a mounting frame and a main frame; the mounting frame is detachably mounted on the main frame to form the paper outlet; the cutter, the paper guide strip and the baffle are mounted on the mounting frame.

As a further improvement of the above-mentioned technical solution, the mounting frame is provided with a plurality of rotating buckles that are arranged at intervals in the transverse direction; one end of the baffle away from the rotating end is a connecting end; a plurality of rotating clamping shafts are arranged at the connecting end, and each of the rotating clamping shafts is rotatably clamped with a respective one of the rotating buckles.

As a further improvement of the above-mentioned technical solution, the cutter is provided with a bending clip, and the bending clip is clamped between the paper guide strip and the mounting frame.

As a further improvement of the above-mentioned technical solution, the paper cutting and discharging mechanism further includes an automatic paper discharge mechanism; the automatic paper discharge mechanism includes a paper discharge roller, a paper pressing roller and a paper discharge drive assembly; the paper discharge roller and the paper pressing roller are arranged in parallel and side by side on a paper feeding side of the paper outlet; the paper discharge drive assembly is configured to drive the paper discharge roller to rotate.

As a further improvement of the above-mentioned technical solution, the paper discharge roller is mounted on the main frame, the automatic paper discharge mechanism further includes a paper pressing frame, the paper pressing roller is rotatably mounted on the paper pressing frame, and the paper pressing frame is movably and adjustably arranged relative to the main frame.

As a further improvement of the above-mentioned technical solution, the paper pressing frame is rotatably mounted on the main frame, and a rotation axis of the paper pressing frame and a rotation axis of the paper pressing roller are eccentrically arranged.

As a further improvement of the above-mentioned technical solution, the paper pressing frame is detachably and linearly plugged into the main frame.

In another aspect, an embodiment of the present disclosure further provides a paper dispenser including the paper cutting and discharging mechanism, where the paper dispenser further includes a casing; and the paper outlet is arranged at a bottom of the casing.

Other features and advantages of the present disclosure will be set forth in the following description, and in part will become apparent from the description, or may be understood by practicing the present disclosure.

### BRIEF DESCRIPTION OF DRAWINGS

The present disclosure will be further described below in conjunction with the accompanying drawings and embodiments.

FIG. 1 is a cross-section side view of a paper cutting and discharging mechanism provided by Embodiment I of the present disclosure;

FIG. 2 is a partial enlarged view of portion A in FIG. 1;

FIG. 3 is an exploded view of a paper cutting and discharging mechanism in FIG. 1;

FIG. 4 is an exploded view of a cutter, a paper guide strip, a baffle and a mounting frame in FIG. 1;

FIG. 5 is an exploded view of a paper pressing roller and a paper pressing frame in FIG. 1;

FIG. 6 is an exploded view of a paper cutting and discharging mechanism provided by Embodiment II of the present disclosure;

FIG. 7 is a schematic structural diagram of a paper cutting and discharging mechanism in FIG. 6;

FIG. 8 is a side cross-sectional view of a paper dispenser provided by the present disclosure; and

FIG. 9 is a schematic structural diagram of the paper dispenser in FIG. 8.

Reference numerals:
paper outlet 100; first paper discharge gap 110; second paper discharge gap 120;
cutter 200; bending clip 210;
baffle 300; rotating clamping shaft 310;
paper guide strip 400;
mounting frame 500; rotating buckle 510;
main frame 600;
paper pressing roller 700; clamping block 710; paper discharge roller 720;
paper discharge drive assembly 800;
paper pressing frame 900;
casing 1000; front cover 1100.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “rear”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “a plurality of” is two or more. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “mount”, and “connect” should be understood in a broad sense, and those of ordinary skill in the art can determine the specific meanings of the above words in the present disclosure in a rational way in combination with the specific contents of the technical solutions.

The technical solutions in the present disclosure are clearly and completely elaborated below in combination with accompanying drawings. It is apparent that the described embodiments are only a part of the embodiments of the present disclosure but not all.

During actual use of the existing paper dispenser, the paper roll may become lodged inside a paper outlet, requiring the user to reach into the paper outlet with his/her hand, to pull out the paper roll. This action risks accidental contact with the cutter, leading to scratches to the user's hand. Even during normal operation, the user's hand may inadvertently touch the cutter while reaching into the paper outlet. Therefore, the present disclosure proposes an anti-scratch paper cutting and discharging mechanism, which can achieve an anti-scratch effect without affecting normal paper discharge.

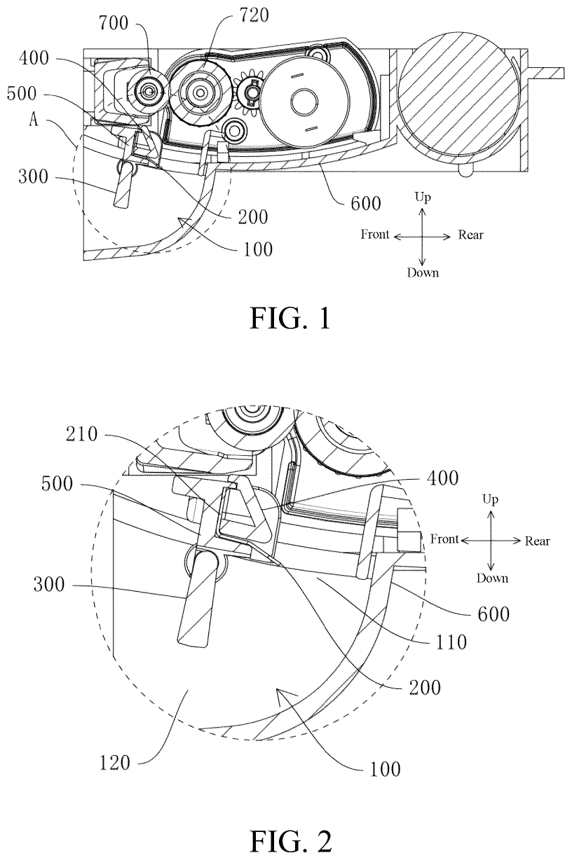

As shown in FIG. 1 and FIG. 2, the paper cutting and discharging mechanism provided by the present disclosure includes a paper outlet 100, a cutter 200, and a baffle 300.

The paper outlet 100 extends in a transverse direction. Specifically, the paper outlet 100 extends in a left-right direction. In some other embodiments, the paper outlet 100 may extend in other directions. This embodiment takes the case where the paper outlet 100 extends in the left-right direction as an example, and the cutter 200 extends in the transverse direction and is arranged on one of inner sides of the paper outlet 100. According to a paper pulling direction, the cutter 200 in this embodiment is arranged on a front inner side of the paper outlet 100. When in use, pulling the paper forward and upward may enable the paper to be in contact with the cutter 200, to achieve cutting of the paper, which is more in line with a daily operation.

As shown in FIG. 2, in this embodiment, a first paper discharge gap 110 is defined between the cutter 200 and the paper outlet 100. The first paper discharge gap 110 extends in the left-right direction, and the paper can be output through the first paper discharge gap 110.

In this embodiment, the baffle 300 may be rotatably arranged at the paper outlet 100, and the baffle 300 and the cutter 200 are located on a same inner side of the paper outlet 100. The cutter 200 and the baffle 300 are arranged in sequence along a paper discharge direction of the paper outlet 100. As shown in FIG. 2, the baffle 300 in this embodiment is arranged below the cutter 200, while a cutting blade of the cutter 200 is arranged backwards. In the up-down direction, upper and lower ends of the baffle 300 are a connecting end and a rotating end respectively. The connecting end of the baffle 300 is rotatably connected to the paper outlet 100. A rotation axis of the baffle 300 extends in a left-right direction and is arranged adjacent to the cutter 200. The rotating end rotates back and forth around the connecting end. In a natural state, the rotating end of the baffle 300 is freely suspended at the paper outlet 100, as shown in FIG. 2, a second paper discharge gap 120 is defined between the rotating end of the baffle 300 and the paper outlet 100, the second paper discharge gap 120 also extends in the left-right direction, and the paper can be output through the second paper discharge gap 120.

A width of the second paper discharge gap 120 is smaller than that of the first paper discharge gap 110, such that the rotating end of the baffle 300 can be rotated in a direction opposite to the paper discharge direction to cover the cutter 200. The direction opposite to the paper discharge direction in this embodiment refers to rearward and upward.

When in use, the paper is output along the first paper discharge gap 110 and the second paper discharge gap 120. When the paper needs to be cut off, the paper is pulled to be in contact with the cutter 200, and the paper is cut off through the cutter 200. When a user reaches into the paper outlet 100 with his/her hand, the rotating end of the baffle 300 will swing with the hand to cover the cutter 200 and prevent the hand from touching the cutter 200, thereby achieving an anti-scratch effect without affecting normal paper discharge.

Further, as shown in FIG. 2, in this embodiment, the paper cutting and discharging mechanism further includes a paper guide strip 400, which is arranged on one side of the cutter 200 away from the baffle 300. The paper guide strip 400 is configured to guide the paper to prevent the paper from stacking on the cutter 200 and affecting the normal paper discharge.

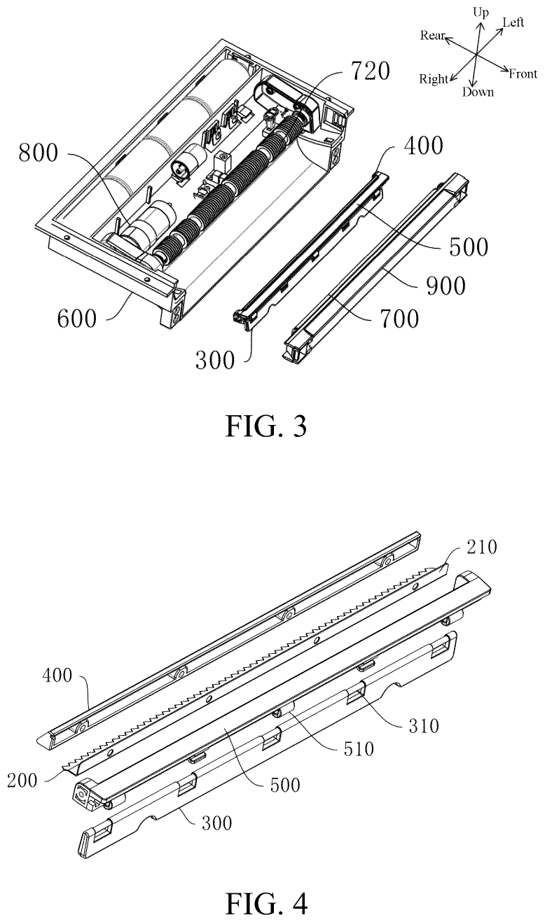

As shown in FIG. 1 and FIG. 3, in this embodiment, the paper cutting and discharging mechanism further includes a mounting frame 500 and a main frame 600. The mounting frame 500 is detachably mounted on the main frame 600 to form the paper outlet 100. The cutter 200, the paper guide strip 400 and the baffle 300 are mounted on the mounting frame 500, to achieve modular assembly. During production, the cutter 200, the paper guide strip 400 and the baffle 300 may be mounted on the mounting frame 500 in advance to form a module, and then assembled on the main frame 600, which facilitates assembly. In addition, paper loading is also facilitated. The mounting frame 500 may be removed for loading paper without interleaving the paper.

As shown in FIG. 3, in this embodiment, left and right ends of the mounting frame 500 are clamped with the main frame 600, respectively. The paper outlet 100 is formed after the mounting frame 500 is assembled. The paper outlet 100 in this embodiment is of a combined structure.

As for the mounting method of the baffle 300, as shown in FIG. 4, in this embodiment, the mounting frame 500 is provided with a plurality of rotating buckles 510 that are arranged at intervals in the left-right direction, a plurality of rotating clamping shafts 310 are arranged at the connecting end of the baffle 300, and each of the rotating clamping shafts 310 is rotatably clamped with a respective one of the rotating buckles 510, with convenient assembly.

In some other embodiments, the connecting end of the baffle 300 may be directly connected to the mounting bracket 500 through a connecting shaft.

As for the mounting method of the cutter 200, as shown in FIG. 2 and FIG. 4, in this embodiment, the cutter 200 is provided with a bending clip 210, and the bending clip 210 is arranged in an included angle. The bending clip 210 is clamped between the paper guide strip 400 and the mounting frame 500, and the paper guide strip 400 is fixed to the mounting frame 500 by screws.

Further, as shown in FIG. 1 and FIG. 3, in this embodiment, the paper cutting and discharging mechanism further includes an automatic paper discharge mechanism. The automatic paper discharge mechanism includes a paper discharge roller 720, a paper pressing roller 700 and a paper discharge drive assembly 800. Both the paper discharge roller 720 and the paper pressing roller 700 are arranged in the left-right extension. The paper discharge roller 720 and the paper pressing roller 700 are arranged in parallel and side by side on a paper feeding side of the paper outlet 100. The paper is discharged from the first paper discharge gap 110 and the second paper discharge gap 120 in sequence after passing through the paper discharge roller 720 and the paper pressing roller 700. The paper is pressed against the paper discharge roller 720 by the paper pressing roller 700, and then the paper discharge roller 720 is driven to rotate by the paper discharge drive assembly 800, to achieve the automatic output of the paper.

The paper discharge drive assembly 800 uses a motor to drive the paper pressing roller 700. Transmission between the motor and the paper pressing roller 700 is achieved by a transmission structure, and the transmission structure may be in the form of a gear or a transmission belt.

As shown in FIG. 3 and FIG. 4, in this embodiment, the paper discharge roller 720 is mounted on the main frame 600. The automatic paper discharge mechanism further includes a paper pressing frame 900. The paper pressing roller 700 is rotatably mounted on the paper pressing frame 900, and the paper pressing frame 900 is movably and adjustably arranged relative to the main frame 600, which facilitates paper loading. When loading paper, the paper pressing roller 700 is separated from the paper discharge roller 720, the paper passes through the paper pressing roller 700 and the paper discharge roller 720, and then the paper pressing roller 700 is mounted, to press the paper against an outer peripheral wall of the paper discharge roller 720.

In addition, the present disclosure also achieves modular assembly. During assembly, the paper pressing roller 700 can be mounted on the paper pressing frame 900 in advance, and then assembly can be performed.

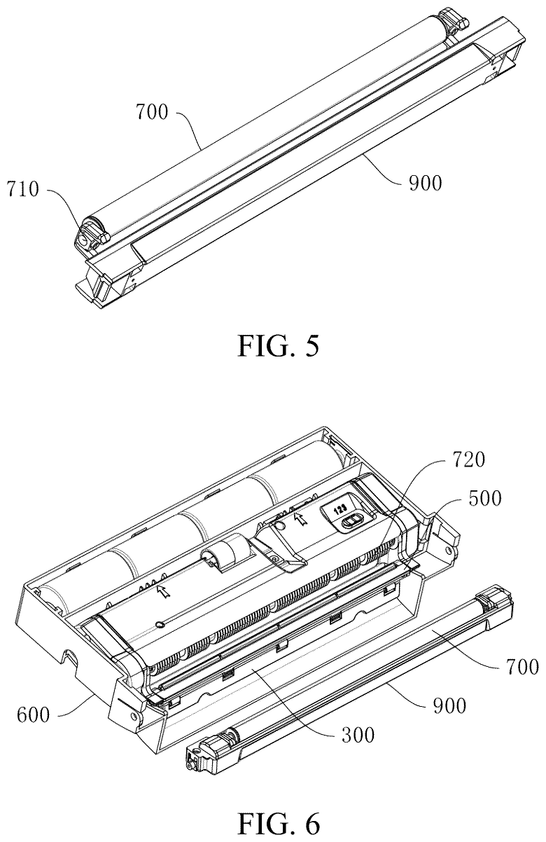

As shown in FIG. 5, in this embodiment, left and right ends of the paper pressing roller 700 are both provided with clamping blocks 710. The clamping blocks 710 are clamped with the paper pressing frame 900, to achieve rapid assembly of the paper pressing roller 700 and the paper pressing frame 900.

As for the mounting method for the paper pressing frame 900, as shown in FIG. 3, in this embodiment, the paper pressing frame 900 is detachably and linearly plugged into the main frame 600. Left and right ends of the paper pressing frame 900 are plugged into the main frame 600 in the front-back direction, respectively.

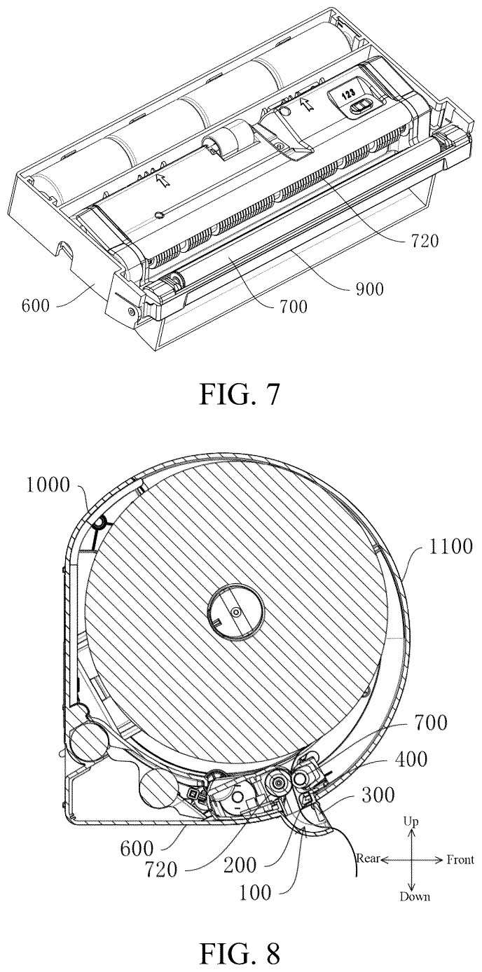

In some other embodiments, as shown in FIG. 6 and FIG. 7, in this embodiment, the paper pressing frame 900 is rotatably mounted on the main frame 600. A rotation axis of the paper pressing frame 900 and a rotation axis of the paper pressing roller 700 are eccentrically arranged. When loading paper, the paper pressing frame 900 is turned outward to separate the paper pressing roller 700 from the paper discharge roller 720. After the paper is loaded, the paper pressing frame 900 is reset.

In some other embodiments, as shown in FIG. 8, in this embodiment, the paper pressing frame 900 is mounted on a front cover 1100 of a casing 1000. The front cover 1100 is rotatably connected to the casing 1000. When the front cover 1100 is opened, the paper pressing roller 700 and the paper discharge roller 720 can be separated from each other. When the front cover 1100 is closed, the paper pressing roller 700 and the paper discharge roller 720 press the paper tightly.

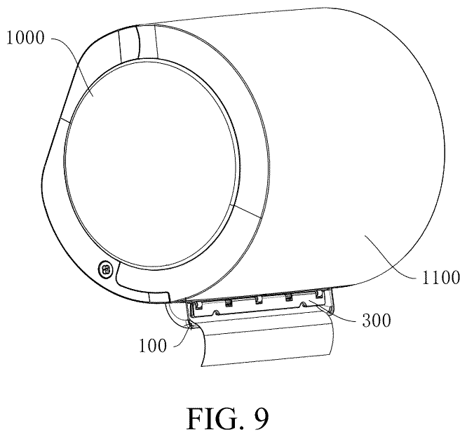

In addition, as shown in FIG. 8 and FIG. 9, the present disclosure further proposes a paper dispenser, including the paper cutting and discharging mechanism. The paper dispenser further includes a casing 1000. The paper outlet 100 is arranged at a bottom of the casing 1000. The main frame 600 is mounted in the casing 1000. In some other embodiments, the main frame 600 may be integrated with the casing 1000.

In this embodiment, a paper roll mounting cavity is arranged in the casing 1000. The paper roll mounting cavity communicates with the paper outlet 100, and the paper roll is mounted in the paper roll mounting cavity.

In the description of the specification, the description with reference to the terms such as “one embodiment”, “some embodiments”, “schematic embodiment”, “example”, “specific example”, or “some examples” intends to be included in at least one embodiment or example of the present disclosure in combination with the specific characteristics, structures, materials or features of this embodiment or example. In this specification, the schematic expression of the above terms does not necessarily refer to the same embodiment or example. Moreover, the described specific characteristics, structures, materials or features may be combined in one or more embodiments or examples in a suitable manner.

The embodiments of the present disclosure are described in detail above in combination with the accompanying drawings. However, the present disclosure is not limited to the above embodiments. Various changes may also be made within the knowledge scope of those of ordinary skill in the art without departing from the gist of the present disclosure.

What is claimed is:

1. An anti-scratch paper cutting and discharging mechanism, comprising:
a paper outlet;
a cutter extending in a transverse direction and arranged on one of inner sides of the paper outlet, wherein a first paper discharge gap is defined between the cutter and the paper outlet; and
a baffle rotatably arranged at the paper outlet, wherein the baffle and the cutter are located on a same inner side of the paper outlet, the cutter and the baffle are arranged in sequence along a paper discharge direction of the paper outlet, a rotation axis of the baffle extends in the transverse direction and is arranged adjacent to the cutter, one end of the baffle away from the rotation axis of the baffle is a rotating end, a second paper discharge gap is defined between the rotating end and the paper outlet, and a width of the second paper discharge gap is smaller than a width of the first paper discharge gap, such that the rotating end is capable of covering the cutter by rotating in a direction opposite to the paper discharge direction.

2. The paper cutting and discharging mechanism according to claim 1, further comprising a paper guide strip arranged on one side of the cutter away from the baffle.

3. The paper cutting and discharging mechanism according to claim 2, further comprising a mounting frame and a main frame, wherein the mounting frame is detachably mounted on the main frame to form the paper outlet; and the cutter, the paper guide strip and the baffle are mounted on the mounting frame.

4. The paper cutting and discharging mechanism according to claim 3, wherein the mounting frame is provided with a plurality of rotating buckles that are arranged at intervals in the transverse direction; one end of the baffle away from the rotating end is a connecting end; a plurality of rotating clamping shafts are arranged at the connecting end, and each of the rotating clamping shafts is rotatably clamped with a respective one of the rotating buckles.

5. The paper cutting and discharging mechanism according to claim 3, wherein the cutter is provided with a bending clip, and the bending clip is clamped between the paper guide strip and the mounting frame.

6. The paper cutting and discharging mechanism according to claim 3, further comprising an automatic paper discharge mechanism, wherein the automatic paper discharge mechanism comprises a paper discharge roller, a paper pressing roller and a paper discharge drive assembly; the paper discharge roller and the paper pressing roller are arranged in parallel and side by side on a paper feeding side of the paper outlet; the paper discharge drive assembly is configured to drive the paper discharge roller to rotate.

7. The paper cutting and discharging mechanism according to claim 6, wherein the paper discharge roller is mounted on the main frame, the automatic paper discharge mechanism further comprises a paper pressing frame, the paper pressing roller is rotatably mounted on the paper pressing frame, and the paper pressing frame is movably and adjustably arranged relative to the main frame.

8. The paper cutting and discharging mechanism according to claim 7, wherein the paper pressing frame is rotatably mounted on the main frame, and a rotation axis of the paper pressing frame and a rotation axis of the paper pressing roller are eccentrically arranged.

9. The paper cutting and discharging mechanism according to claim 7, wherein the paper pressing frame is detachably and linearly plugged into the main frame.

10. A paper dispenser, comprising the paper cutting and discharging mechanism according to claim 1, wherein the paper dispenser further comprises a casing; and the paper outlet is arranged at a bottom of the casing.
